(19) United States
(12) Patent Application Publication
(10) Pub. No.: US 2023/0351568 A1
(43) Pub. Date: Nov. 2, 2023

(54) REFLECTION-COMPONENT-REDUCED IMAGE GENERATING DEVICE, REFLECTION COMPONENT REDUCTION INFERENCE MODEL GENERATING DEVICE, REFLECTION-COMPONENT-REDUCED IMAGE GENERATING METHOD, AND PROGRAM

(71) Applicant: Konica Minolta, Inc., Tokyo (JP)

(72) Inventors: TAKASHI MORIMOTO, Suita-shi, Osaka (JP); MOTOHIRO ASANO, Higashisumiyoshi-ku, Osaka-shi, Osaka (JP)

(21) Appl. No.: 17/925,231

(22) PCT Filed: May 14, 2021
(86) PCT No.: PCT/JP2021/018407

§ 371 Date: Nov. 14, 2022

(30) Foreign Application Priority Data
Jun. 10, 2020 (JP) 2020-100650

(51) Int. Cl. G06T 5/50; G06T 7/00; G01M 3/04

(52) U.S. Cl. CPC G06T 5/50; G06T 7/0004; G01M 3/04; G06T 2207/20212; G06T 2207/20081; H04N 23/56

(57) ABSTRACT

There are provided an inspection image input unit that receives a gas distribution image as an input, the gas distribution image having a visualized presence region of a gas in a space and including an image portion in which a target is irradiated with light, and a reflection-component-reduced image generating unit that generates a reflection-component-reduced image in which an image component of reflected light in the image portion of the gas distribution image received by the inspection image input unit is reduced using an estimation model machine-learned using, as teacher data, a combination of a first image including an image portion in which a target is irradiated with light and a second image including an image portion in which the target is not irradiated with light, the second image being equivalent to the first image for elements other than the image portion.

### TECHNICAL FIELD

The present disclosure relates to a reflection-component-reduced image generating device, a reflection component reduction inference model generating device, a reflection-component-reduced image generating method, and a program, and particularly relates to detection and reduction using machine learning of an image component including high-luminance reflected light generated by a flare stack or the like of a gas facility.

### BACKGROUND ART

In facilities that use gas (hereinafter may also be referred to as “gas facilities”), such as production facilities that produce natural gas and oil, production plants that produce chemical products using gas, gas pipe transmission facilities, petrochemical plants, thermal power plants, and iron-related facilities, a risk of gas leakage is recognized due to aged deterioration of facilities and operational errors, and a gas detection device is provided to minimize the gas leakage.

In this gas detection, in addition to the gas detection device using a fact that electrical characteristics of a detection probe are changed by contact of gas molecules with the probe, in recent years, an optical gas leakage detection method has been employed in which an infrared moving image is captured using infrared absorption characteristics of gas to detect gas leakage in an inspection region (for example, Patent Literatures 1 and 2). In the gas detection method by the infrared moving image, since the gas can be visualized by the image, the emission state of the flow of gas or the like and a leakage position can be easily detected.

CITATION LIST

### Patent Literature

Patent Literature 1: WO 2016/143754 A

Patent Literature 2: WO 2017/150565 A

Patent Literature 3: JP 2013-121099 A

### SUMMARY OF INVENTION

### Technical Problem

However, in order to detoxify surplus gas generated during operation, a gas plant or a petrochemical plant is generally provided with equipment called a flare stack for burning the surplus gas. Flames generated by gas combustion cause the flare stack tip to be in a very high temperature state, so that a large amount of infrared rays are emitted from this portion.

FIG. 17 is a schematic view illustrating a mode of reflected light based on a flare stack in a gas facility. When the flare stack is observed by a gas visualization imaging device, as illustrated in FIG. 17, equipment around the flare stack is illuminated by emitted infrared rays and is observed as a high-luminance reflection component. Further, since the infrared luminance and shape of the flame change from moment to moment, illuminance of the high-luminance reflection component also changes from moment to moment.

Accordingly, a change in the amount of high-intensity infrared rays different from that of a detection target gas is observed, and thus there is a problem that it is difficult to observe the change in the amount of infrared rays due to the detection target gas, and the gas detection rate is extremely lowered.

The present disclosure has been made in view of the above problem, and an object thereof is to provide a reflection-component-reduced image generating device, a reflection component reduction inference model generating device, a reflection-component-reduced image generating method, and a program that reduce the influence of a change in amount of infrared rays by a high-luminance light source in a gas facility from an output image of a gas visualization imaging device.

### Solution to Problem

A reflection-component-reduced image generating device according to an aspect of the present disclosure includes an inspection image input unit that receives a gas distribution image as an input, the gas distribution image having a visualized presence region of a gas of a space and including an image portion in which a target is irradiated with light, and a reflection-component-reduced image generating unit that generates a reflection-component-reduced image in which an image component of reflected light in the image portion of the gas distribution image received by the inspection image input unit is reduced using an estimation model machine-learned using, as teacher data, a combination of a first image including an image portion in which a target is irradiated with light and a second image including an image portion in which the target is not irradiated with light, the second image being equivalent to the first image for elements other than the image portion.

### Advantageous Effects of Invention

With a reflection-component-reduced image generating device, a reflection component reduction inference model generating device, a reflection-component-reduced image generating method, and a program according to one aspect of the present disclosure, it is possible to reduce the influence of a change in the amount of infrared rays due to a high-luminance light source in a gas facility from an output image of a gas visualization imaging device, and it is possible to contribute to improvement of detection quality in gas leakage detection.

### BRIEF DESCRIPTION OF DRAWINGS

FIG. 1 is a schematic configuration diagram of a reflection-component-reduced image generating system according to an embodiment.

FIG. 2 is a schematic diagram illustrating a relationship between a monitoring target 300 and gas visualization imaging devices 10.

FIG. 3 is a diagram illustrating a configuration of a reflection-component-reduced image generating device 20.

FIG. 4(a) is a functional block diagram of a control unit 21, and FIG. 4(b) is a schematic diagram illustrating an outline of a logical configuration of a machine learning model.

FIG. 5 is a schematic diagram for describing characteristics of an image component of reflected light based on a flare stack in a gas distribution image.

FIG. 6 is a functional block diagram of a machine learning data generating device 30.

FIG. 7 is a functional block diagram in a control unit of the machine learning data generating device 30.

FIGS. 8(a) and 8(b) are schematic views illustrating data structures of structure three-dimensional data and optical reflection three-dimensional image data, respectively.

FIG. 9 is a schematic view for describing an outline of an optical reflection image calculation method in two-dimensional single viewpoint optical reflection image conversion processing.

FIG. 10 is a flowchart illustrating an outline of two-dimensional optical reflection image generation processing as a teacher image in the machine learning data generating device 30.

FIG. 11 is a flowchart illustrating an outline of two-dimensional single viewpoint reflection component image conversion processing.

FIG. 12 is a flowchart illustrating operation of the reflection-component-reduced image generating device 20 in a learning phase.

FIG. 13 is a flowchart illustrating an operation of the reflection-component-reduced image generating device 20 in an operation phase.

FIG. 14 is a process diagram illustrating an outline of an imaging process of a teacher image.

FIG. 15 is a functional block diagram in a control unit of a machine learning data generating device 30A according to a second embodiment.

FIG. 16 is a flowchart illustrating an outline of reflection component emphasizing processing in the machine learning data generating device 30A.

FIG. 17 is a schematic view illustrating a mode of the reflected light based on the flare stack in a gas facility.

### DESCRIPTION OF EMBODIMENTS

<<First Embodiment>>

<Configuration of Reflection-Component-Reduced Image Generating System 1>

An embodiment of the present disclosure is implemented as a reflection-component-reduced image generating system 1 that reduces an image component of reflected light in an inspection image including a background image portion in which an imaging target is irradiated with high-luminance light of a flare stack or the like in a gas facility. Hereinafter, the reflection-component-reduced image generating system 1 according to the embodiment will be described in detail with reference to the drawings.

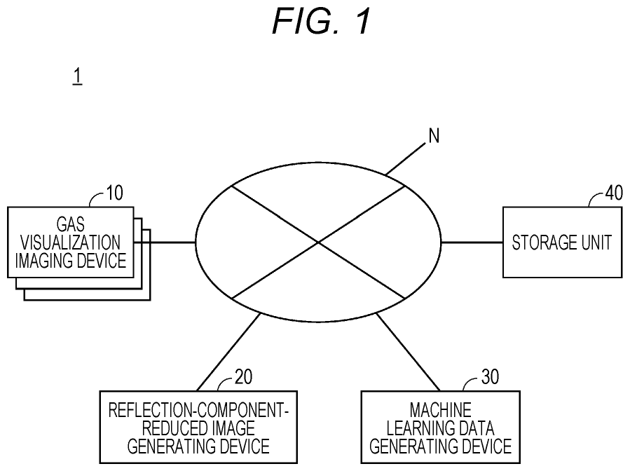

FIG. 1 is a schematic configuration diagram of the reflection-component-reduced image generating system 1 according to the embodiment. As illustrated in FIG. 1, the reflection-component-reduced image generating system 1 includes a plurality of gas visualization imaging devices 10, a reflection-component-reduced image generating device 20, a machine learning data generating device 30, and a storage unit 40, which are connected to a communication network N.

The communication network N is, for example, the Internet, and the gas visualization imaging device 10, the reflection-component-reduced image generating device 20, the plurality of machine learning data generating devices 30, and the storage unit 40 are connected so as to be able to exchange information with each other.

(Gas Visualization Imaging Device 10 and Others)

The gas visualization imaging device 10 is a device or a system that images a monitoring target using infrared rays and provides an infrared image in which gas is visualized to the reflection-component-reduced image generating device 20. For example, an imaging unit (not illustrated) including an infrared camera that detects and captures an infrared ray, and an interface circuit (not illustrated) that performs output to the communication network N are provided.

An image by the infrared camera is generally used for detecting a hydrocarbon-based gas. For example, it is an image sensor having a sensitivity wavelength band in at least a part of an infrared light wavelength of 3 μm to 5 μm, more preferably, for example, what is called an infrared camera that detects and images infrared light having a wavelength of 3.2 to 3.4 μm, and is capable of detecting hydrocarbon-based gases such as methane, ethane, ethylene, and propylene.

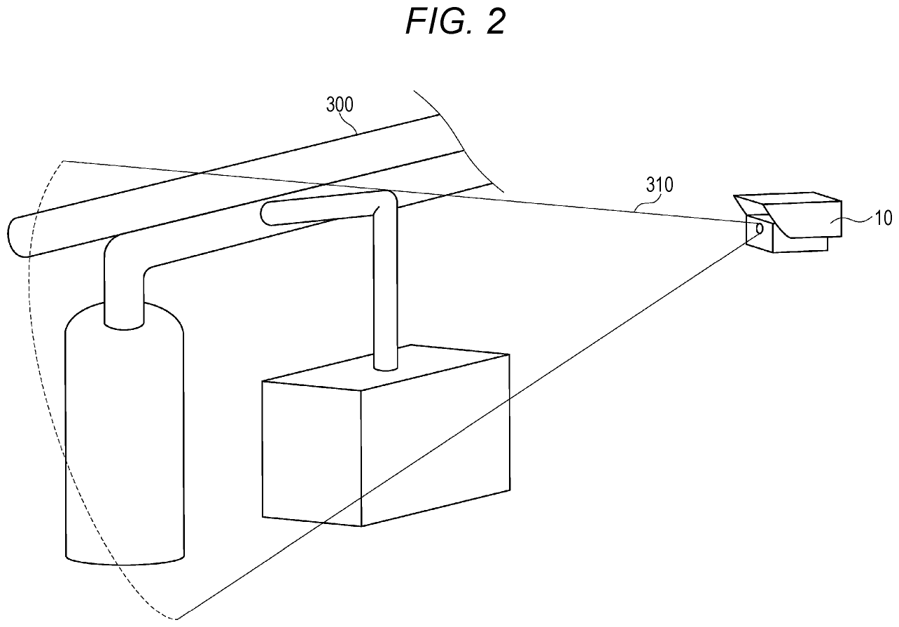

As illustrated in the schematic diagram of FIG. 2, the gas visualization imaging device 10 is installed such that the monitoring target 300 is included in a visual field range 310 of the infrared camera. An obtained inspection image is, for example, a video signal for transmitting an image of 30 frames per second. The gas visualization imaging device 10 converts a captured image into a predetermined video signal. In the present embodiment, an infrared image signal acquired from the infrared camera is processed as a moving image including a plurality of frames by restoring the video signal to an image. The image is an infrared photograph obtained by imaging a monitoring target, and has intensity of infrared rays as a pixel value.

Note that if the size of a gas distribution image or the number of frames as a moving image is excessive, the calculation amounts of machine learning and determination based on machine learning increase. In the first embodiment, the number of pixels of the gas distribution image is 224×224 pixels, and the number of frames is 16.

The gas visualization imaging device detects the presence of gas by capturing a change in the amount of electromagnetic waves emitted from a background object having an absolute temperature of 0 (K) or more. The change in the amount of electromagnetic waves is mainly caused by absorption of electromagnetic waves in the infrared region by the gas or generation of blackbody radiation from the gas itself. In the gas visualization imaging device 10, since a gas leakage can be grasped as an image by image-capturing the monitoring target space, it is possible to detect the gas leakage earlier and accurately grasp the location where the gas is present as compared with a conventional detection probe type that can only monitor a lattice point-like position.

The visualized inspection image is temporarily stored in a memory or the like, transferred to the storage unit 40 via the communication network N on the basis of an operation input, and stored therein.

Note that the gas visualization imaging device 10 is not limited to this and may be any imaging device as long as it is capable of detecting the gas to be monitored, and may be, for example, a general visible light camera as long as the monitoring target is gas that can be detected by visible light, such as white smoked water vapor. Note that, in the present description, the gas refers to a gas that has leaked from a closed space such as a pipe or a tank and refers to gas that has not been intentionally diffused into the atmosphere.

Returning to FIG. 1, the storage unit 40 is a storage device that stores the inspection image transmitted from the gas visualization imaging device 10, and includes, for example, a volatile memory such as a dynamic random access memory (DRAM) and a nonvolatile memory such as a hard disk.

(Reflection-Component-Reduced Image Generating Device 20)

The reflection-component-reduced image generating device 20 is a device that acquires an inspection image obtained by imaging the monitoring target from the gas visualization imaging device 10, reduces an image component of reflected light in the background image portion in which the imaging target is irradiated with high-luminance light of the flare stack or the like, and provides a reflection-component-reduced image in which the image component of the reflected light is reduced to a user through the display unit 24. The reflection-component-reduced image generating device 20 is achieved, for example, as a computer including a general central processing unit (CPU), a random access memory (RAM), and a program executed by these. Note that, as described later, the reflection-component-reduced image generating device 20 may further include a graphics processing unit (GPU) as an arithmetic device and a RAM.

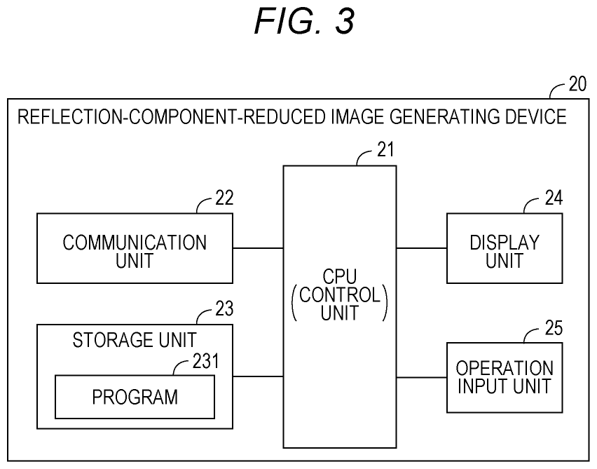

Hereinafter, a configuration of the reflection-component-reduced image generating device 20 will be described. FIG. 3 is a diagram illustrating a configuration of the reflection-component-reduced image generating device 20. As illustrated in FIG. 3, the reflection-component-reduced image generating device 20 includes a control unit (CPU) 21, a communication unit 22, a storage unit 23, a display unit 24, and an operation input unit 25, and is achieved as a computer that executes a gas leakage detection program by the control unit 21.

The communication unit 22 transmits and receives information to and from the reflection-component-reduced image generating device 20 and the storage unit 40.

The display unit 24 is, for example, a liquid crystal panel or the like, and displays a display screen generated by the CPU 21.

The storage unit 23 stores a program 231 and the like necessary for operation of the reflection-component-reduced image generating device 20, and has a function as a temporary storage area for temporarily storing a calculation result of the CPU 21. The storage unit 23 includes, for example, a volatile memory such as a DRAM and a nonvolatile memory such as a hard disk.

The control unit 21 implements respective functions of the reflection-component-reduced image generating device 20 by executing the gas leakage detection program 231 in the storage unit 23.

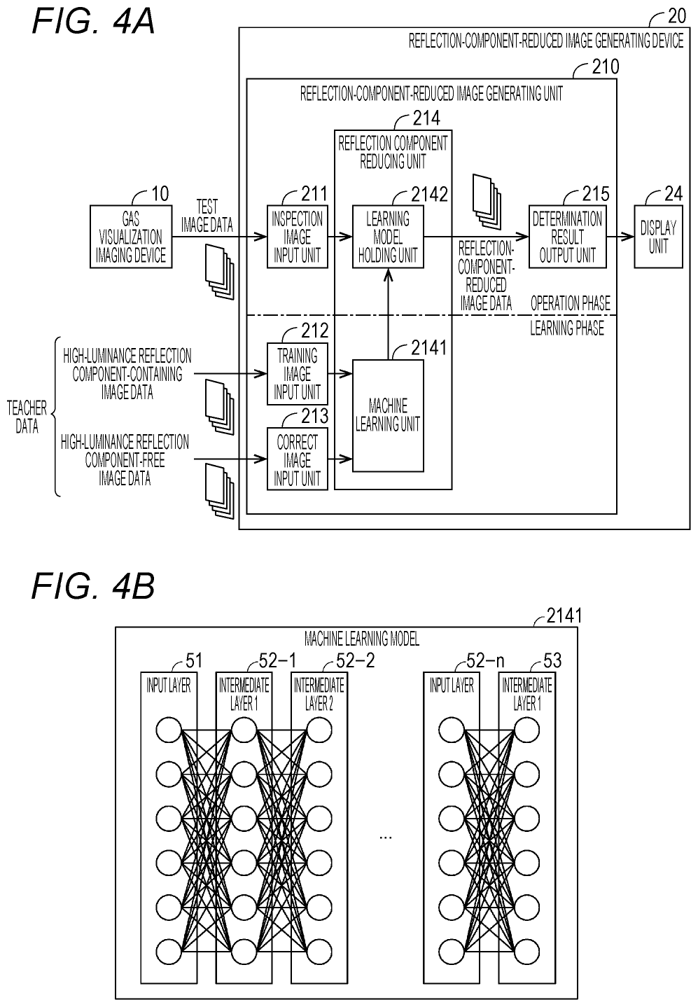

FIG. 4(a) is a functional block diagram of the control unit 21.

As illustrated in FIG. 4(a), the reflection-component-reduced image generating device 20 includes an inspection image input unit 211, a training image input unit 212, a correct image input unit 213, a machine learning unit 2141, a learning model bolding unit 2142, and a determination result output unit 215. The machine learning unit 2141 and the learning model holding unit 2142 constitute a reflection component reducing unit 214. Further, the inspection image input unit 211, the training image input unit 212, the correct image input unit 213, the reflection component reducing unit 214, and the determination result output unit 215 constitute a reflection-component-reduced image generating unit 210.

The inspection image input unit 211 is a circuit that acquires an inspection image from the gas visualization imaging device 10. For example, a device that captures image data into a processing device such as a computer, such as an image capture board, can be used. The inspection image is an infrared image captured by the infrared camera, and is an image illustrating a gas distribution obtained by visualizing a gas leakage portion as an inspection target. The inspection image may be a moving image including time-series data of a plurality of frames. In a case where high-luminance light generated by the flare stack or the like is imaged by the gas visualization imaging device 10, there is a possibility that a background image portion generated by light emitted to an imaging target such as a gas facility is included in the inspection image. Gain adjustment, offset adjustment, image inversion processing, and the like may be performed as necessary for subsequent processing.

The training image input unit 212 is a circuit that receives an input of a reflection component-containing image (hereinafter may also be referred to as a “first image”) that is an image having the same format as the inspection image generated by the gas visualization imaging device 10 and contains an image component of high-luminance reflected light in an image portion in which a target such as a gas facility is irradiated with the high-luminance light generated by the flare stack or the like. The first image may be a moving image including time-series data of a plurality of frames. The first image is output to the machine learning unit 2141 as a training image for machine learning.

Note that, in a case where the acquired image does not have the same format as the gas distribution image generated by the inspection image input unit 211, the training image input unit 212 may perform processing such as cutting out or scaling so as to have the same format. Further, for example, in a case where the acquired image is three-dimensional voxel data, conversion may be performed to a two-dimensional image of a viewpoint from one point.

The correct image input unit 213 is a circuit that receives an input of a reflection component-free image (hereinafter may also be referred to as a “second image”) that is an image having the same format as the inspection image generated by the gas visualization imaging device 10 and does not include an image component of high-luminance reflected light in an image portion in which a target such as a gas facility is irradiated with the high-luminance light generated by the flare stack or the like. The second image may also be a moving image including time-series data of a plurality of frames.

The second image is an image in which elements other than the image component of reflected light are imaged or generated under the same condition with respect to the same target as that of the first image to be a pair forming a group. The second image is output to the machine learning unit 2141 as a correct image for machine learning .

The machine learning unit 2141 is a circuit that executes machine learning on the basis of a combination of the first image received by the training image input unit 212 and the second image received by the correct image input unit 213 and generates a machine learning model. As the machine learning, for example, a convolutional neural network (CNN) can be used, and known software such as PyTorch can be used.

FIG. 4(b) is a functional block diagram of the machine learning unit 2141 in the control unit 21. The machine learning model includes an input layer 51, an intermediate layer 52-1, intermediate layers 52-2, . . . , an intermediate layer 52-n, and an output layer 53, and an interlayer filter is optimized by learning. For example, in a case where the number of pixels of an image to be processed is 224×224 pixels and the number of frames is 16, the input layer 51 receives a 224×224×16 three-dimensional tensor to which a pixel value of the image to be processed has been input. The intermediate layer 52-1 is, for example, a convolution layer, and receives a three-dimensional tensor of 224×224×16 generated by a convolution operation from data of the input layer 51. The intermediate layer 52-2 is, for example, a pooling layer, and receives a three-dimensional tensor obtained by resizing data of the intermediate layer 52-1. The intermediate layer 52-n is, for example, a fully connected layer, and converts data of the intermediate layer 52-(n−1) into a two-dimensional vector indicating a coordinate value. Note that the configuration of the intermediate layer is an example, and the number n of the intermediate layers is about 3 to 5, but is not limited thereto. Further, FIG. 4(b) is drawn such that the number of neurons in each layer is the same, but each layer may have any number of neurons. The machine learning unit 2141 receives a moving image as an image to be processed as an input, performs learning in which a gas leakage position is a correct answer and generates a machine learning model, and outputs the machine learning model to the learning model holding unit 2142.

In the reflection component reducing unit 214 according to the present embodiment, the machine learning unit 2141 includes a machine learning model including the input layer 51, the intermediate layer 52, and the output layer 53, and a model learning processing program. Each of the intermediate layers 52-1, 52-2 . . . 52-n includes a plurality of processing layers such as a convolution layer and a MaxPooling layer, and the reflection component-free image of the same scene and a reflection component-containing image obtained by adding a reflection component to the reflection component-free image are input as the correct image to the input layer 51 via the training image input unit 212 and the correct image input unit 213, respectively.

The output layer 53 is a portion where a result in the middle of learning is output for each learning step. The machine learning model is formed by the model learning processing program through a procedure of correcting the parameters (weight, gain, and the like of each node) of the intermediate layers 52-1, 52-2 . . . 52-n while comparing the output result with the correct image.

Learning accuracy of the machine learning model can be improved by inputting a large number of pieces of learning data to the machine learning unit 2141, the learning data being a set of the correct image that is a high-luminance reflection component-free image and a high-luminance reflection component-containing image obtained by adding the high-luminance reflection component to the correct image.

Note that, in a case where the reflection-component-reduced image generating device 20 includes a GPU and a RAM as arithmetic devices, the machine learning unit 2141 may be achieved by the GPU and software.

In general, in machine learning, a processing system capable of executing processing close to human shape recognition or recognition with respect to temporal change is constructed by automatically adjusting parameters such as convolution filter processing used in image recognition or the like through a learning process. In the machine learning model of the reflection component reducing unit 214 according to the present embodiment, it is possible to estimate a location where the reflection component is generated by capturing a change portion of a synchronized high-luminance signal appearing in the input image and to generate the reflection-component-reduced image.

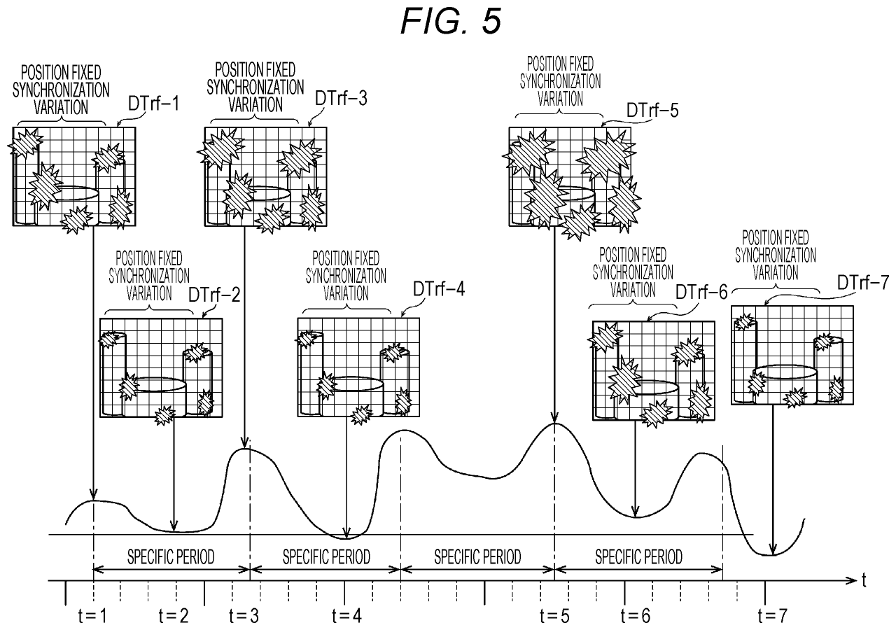

Specifically, as illustrated in FIG. 5, a learning model for generating an image in which the high-luminance reflection component is reduced is estimated on the basis of the following characteristics of the high-luminance reflected light image component.

FIG. 5 is a schematic diagram for describing characteristics of image components of high-luminance reflected light based on the flare stack in a gas distribution image. The image component of the high-luminance reflected light based on the flare stack is the light based on the flare stack reflected by the structure and imaged by the gas visualization imaging device 10. The high-luminance reflected light image component has the following characteristics. Specifically, (1) the position of the high-luminance reflected light image component in the gas distribution image is fixed. (2) Temporal changes are synchronized among a plurality of high-luminance reflected light image components in the gas distribution image. (3) The magnitude relationship of the luminance does not change among the plurality of high-luminance reflected light image components in the gas distribution image. (4) Even if there is a luminance variation in the high-luminance reflected light image component, the shape of an outer periphery does not change, and the luminance distribution in the high-luminance reflected light image component does not relatively change. (5) There is a characteristic that a period of the temporal change between the high-luminance reflected light image components is within a predetermined range, or the like.

Thus, the machine learning model is formed to construct an estimation model of machine learning by extracting a feature amount of the image component of the high-luminance reflected light in the image portion in which the target is irradiated with light in the gas distribution image, for example, an absolute value of luminance, an outer peripheral shape, a luminance distribution, an area, a position, a temporal change of a position, a temporal change of an area, a temporal change of a luminance, a period of a temporal change, synchronism of a temporal change, or the like, or a combination thereof, and predict generation and size of the image component of the high-luminance reflected light.

The learning model holding unit 2142 is a circuit that holds the machine learning model generated by the machine learning unit 2141, and uses the machine learning model to generate and output a reflection-component-reduced image in which an image component of high-luminance reflected light is reduced in a gas distribution image including the image portion in which the target is irradiated with the high-luminance light generated by the flare stack or the like and acquired by the inspection image input unit 211.

Since the learning model holding unit 2142 outputs the high-luminance reflection component in the reflection component-free image with respect to the reflection component-free image, the reflection component reducing unit 214 forms a high-luminance reflection component reduced image in which the high-luminance reflection component in the inspection image is reduced with respect to the input initial inspection image on the basis of the machine learning model generated by the machine learning unit 2141 on the basis of the correspondence relationship between the initial inspection image acquired from the inspection image input unit 211 and the high-luminance reflection component, and calculates an error between the formed high-luminance reflection component reduced image and the correct image. Then, in order to reduce errors, update amounts of the parameters (weight, gain, and the like of each node) of the intermediate layers 52-1, 52-2 . . . 52-n in the neural network are calculated, and calculation of an error between the formation of the high-luminance reflection component reduced image and the correct image is repeated, thereby generating the reflection-component-reduced image in which the high-luminance reflection component is reduced. The update amounts of the parameters can be performed using, for example, a known algorithm such as a gradient method, a nearest neighbor method, or an error back propagation method. Thus, an image in which the reflection component is reduced is generated and output based on the input inspection image including a gas visualized image.

Thus, the learning model holding unit 2142 generates and outputs an image in which the high-luminance reflection component of the inspection image is reduced on the basis of the inspection image including the input gas visualized image on the basis of the machine learning model generated by the machine learning unit 2141. The determination result output unit 215 is a circuit that generates a display image for displaying the second image output by the learning model holding unit 2142 on the display unit 24.

(Machine Learning Data Generating Device 30)

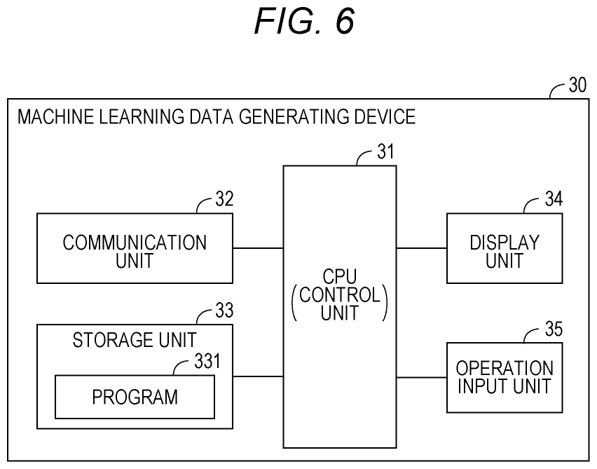

Hereinafter, a configuration of the machine learning data generating device 30 will be described. FIG. 6 is a diagram illustrating a configuration of the machine learning data generating device 30. As illustrated in FIG. 6, the machine learning data generating device 30 includes a control unit (CPU) 31, a communication unit 32, a storage unit 33, a display unit 34, and an operation input unit 35, and is achieved as a computer that executes a machine learning data generating program by the control unit 31.

The control unit 31 implements the function of the machine learning data generating device 30 by executing a machine learning data generating program 331 in the storage unit 33.

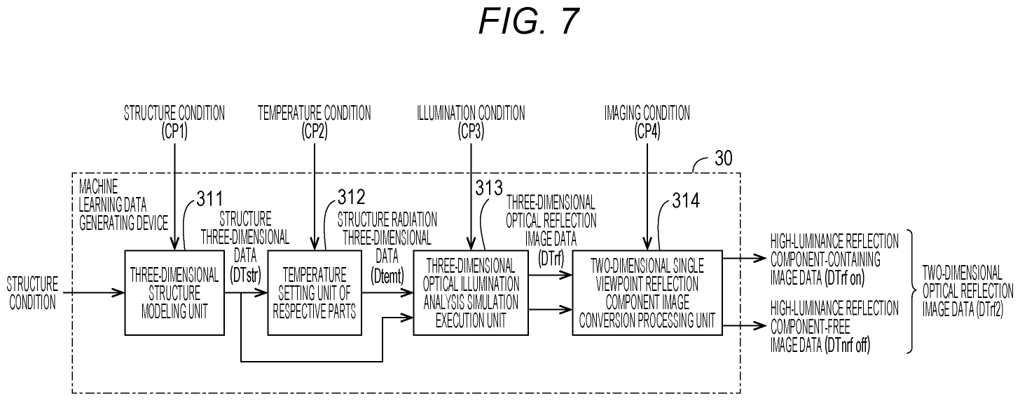

FIG. 7 is a functional block diagram in the control unit of the machine learning data generating device 30. The condition parameters necessary for processing input in each functional block in FIG. 7(a) are as follows.

TABLE 1

| Condition parameter | Example of parameter |
|---|---|
| Structure condition (CP1) | Structure position and structure |
| | surface optical characteristic |
| | (reflectance and emissivity) |
| Temperature condition | Structure temperature and structure |
| (CP2) | ambient temperature |
| Illumination condition | Background illumination |
| (CP3) | (temporal change of intensity) |
| | High-luminance illumination |
| | (ON/OFF, quantity, position, and |
| | temporal change of intensity) |
| Image capturing condition | Imaging device angle of view, |
| (CP4) | viewpoint, line-of-sight direction, |
| | distance, and resolution |

As illustrated in FIG. 7(a), the machine learning data generating device 30 includes a three-dimensional structure modeling unit 311, a temperature setting unit 312 of respective parts, a three-dimensional optical illumination analysis simulation execution unit 313, and a two-dimensional single viewpoint reflection component image conversion processing unit 314.

The three-dimensional structure modeling unit 311 performs three-dimensional structure model design on the basis of an operation input of a condition parameter CP1 to the operation input unit 35 from the operator, performs three-dimensional structure modeling of laying out a structure in a three-dimensional space, and outputs a structure three-dimensional data DTstr to the subsequent stage. Examples of the condition parameter CP1 include parameters related to structure conditions, such as a structure position and structure surface optical characteristics such as reflectance and emissivity. The structure three-dimensional data DTstr is, for example, shape data representing a three-dimensional shape of piping and other plant facilities. For three-dimensional structure modeling, commercially available three-dimensional computer-aided design (CAD) software can be used.

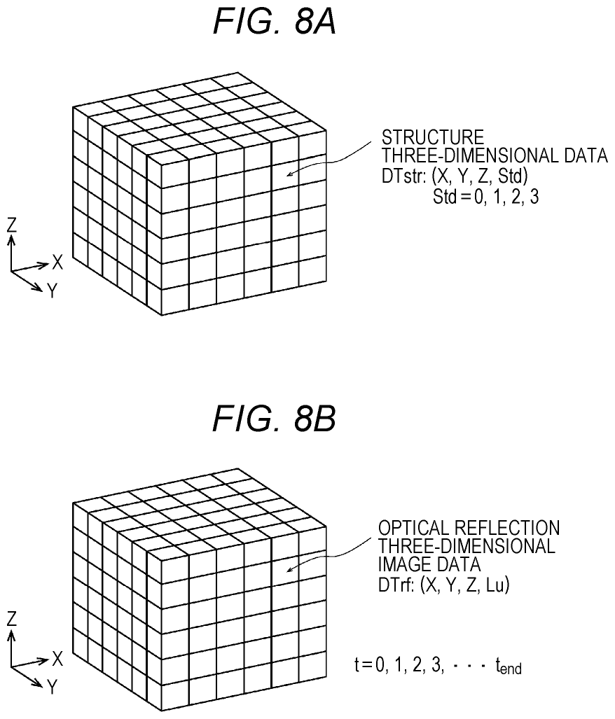

FIG. 8(a) is a schematic view illustrating a data structure of the structure three-dimensional data DTstr. Here, in the present description, an X direction, a Y direction, and a Z direction in each drawing are defined as a width direction, a depth direction, and a height direction, respectively.

As illustrated in FIG. 8(a), the structure three-dimensional data DTstr is three-dimensional voxel data representing a three-dimensional space, and includes pieces of structure identification information Std arranged at coordinates in the X direction, the Y direction, and the Z direction. Since the structure identification information Std is expressed as three-dimensional shape data, for example, the structure identification information Std may be recorded as a binary image of 0 and 1 such as “with structure” or “without structure”. Alternatively, the structure three-dimensional data DTstr may be recorded as a multi-valued image such as 0, 1, 2, 3, and the like by adding a value indicating the classification of the structure surface for each pixel. In this case, the structure three-dimensional data DTstr is identification data including the surface classification Std (Std=0, 1, 2, 3, . . . ) of the structure. Here, the surface classification Std is a classification number classified on the basis of, for example, optical characteristics of the structure surface. For example, unpainted piping may be set to 1, painted piping may be set to 2, and concrete may be set to 3. Thus, the position of the structure and the optical characteristic conditions of the structure surface are set as illustrated in the structure conditions.

The temperature setting unit 312 of respective parts acquires structure three-dimensional data DTstr as an input, further assigns a temperature condition to each part of the structure surface with respect to the structure three-dimensional data DTstr on the basis of an operation input of a condition parameter CP2 to the operation input unit 35 from the operator, and outputs structure radiation three-dimensional data DTemt on the surface of the structure laid out in the three-dimensional space to the subsequent stage. Examples of the condition parameter CP2 include parameters related to temperature conditions such as a structure temperature and a structure ambient temperature. The temperature of the structure itself and the temperature around the structure are set, and for example, a change in the amount of infrared rays depending on the season can also be reflected in learning.

The three-dimensional optical illumination analysis simulation execution unit 313 acquires the structure radiation three-dimensional data DTemt as an input, and further acquires a condition parameter CP3 necessary for optical illumination analysis simulation on the basis of an operation input to the operation input unit 35 of the condition parameter CP3 from the operator. The condition parameter CP3 is, for example, a parameter that defines setting conditions necessary for the optical illumination analysis simulation mainly related to illumination conditions, such as ON/OFF, quantity, position, light emission intensity, and a temporal change thereof of the high-luminance illumination light source such as the flare stack and a temporal change of intensity of background illumination such as a sunshine condition, as illustrated in Table 1. The background illumination is illumination for reproducing a change in illuminance due to the weather, and its intensity is sufficiently lower than that of the high-luminance illumination and changes slowly over time. The high-luminance illumination is illumination that generates a reflection component. In addition to the temporal change of the intensity, the position and the number are set. By generating an image by changing various kinds of the condition parameters, it is possible to generate a large number of pieces of learning data.

Then, the three-dimensional optical illumination analysis simulation is performed in the three-dimensional space in which the three-dimensional structure modeling has been performed, and three-dimensional optical reflection image data DTrf is generated and output to the subsequent stage.

The three-dimensional optical reflection image data DTrf is data including at least a three-dimensional optical reflection characteristic distribution. The calculation is performed using commercially available software for optical illumination analysis simulation, and for example, ANSYS SPEOS may be used.

FIG. 8(b) is a schematic view illustrating a data structure of the three-dimensional optical reflection image data DTrf. As illustrated in FIG. 8(b), the three-dimensional optical reflection image data DTrf is three-dimensional voxel data representing a three-dimensional space, and may include optical reflection surface normal vectors of voxels arranged at coordinates in the X direction, the Y direction, and the Z direction and optical reflection luminance data Lu (W/m²). The optical reflection luminance data Lu of each voxel may have an aspect in which the absolute value changes on the basis of a viewpoint position SP (X, Y, Z) to be described later. The three-dimensional optical reflection image data DTrf may be a moving image including a plurality of pieces of three-dimensional voxel time-series data in time series.

The two-dimensional single viewpoint reflection component image conversion processing unit 314 inputs and acquires the three-dimensional optical reflection image data DTrf, and further acquires a condition parameter CP4 necessary for conversion processing into a two-dimensional single viewpoint image on the basis of an operation input of the condition parameter CP4 to the operation input unit 35 from the operator. The condition parameter CP4 is, for example, a parameter related to the image capturing condition of the gas visualization imaging device, such as an imaging device angle of view, a line-of-sight direction, a distance, and image resolution as illustrated in Table 1. Then, the two-dimensional single viewpoint reflection component image conversion processing unit 314 converts the three-dimensional optical reflection image data DTrf into two-dimensional optical reflection image data DTrf2 observed from a predetermined viewpoint position. Thus, a two-dimensional image captured by the imaging device is generated on the basis of the structure three-dimensional data output by a three-dimensional structure model design and image capturing conditions. Also in this case, the two-dimensional optical reflection image data DTrf2 may be a moving image including time-series data of a plurality of frames.

Then, as the two-dimensional optical reflection image data DTrf2 as teacher data, high-luminance reflection component-containing image data DTrfon (hereinafter may also be referred to as “reflection component-containing image data DTrfon”) based on the three-dimensional optical illumination analysis simulation under the condition that the high-luminance illumination light source is turned on and high-luminance reflection component-free image data DTrfoff (hereinafter may also be referred to as “reflection component-free image data DTrfoff”) based on the three-dimensional optical illumination analysis simulation under the condition that the high-luminance illumination light source is turned off with other condition parameters as common conditions are generated in a pair. The two-dimensional optical reflection image data DTrf2 generated in a pair, that is, a set of the reflection component-containing image data DTrfon and the reflection component-free image data DTrfoff, is output to the reflection-component-reduced image generating device 20 as machine learning teacher data.

The two-dimensional optical reflection image data DTrf2 is an image corresponding to the inspection image acquired by the gas visualization imaging device 10, and is an image representing how the target is viewed from the viewpoint. Furthermore, by considering information of the structure three-dimensional data DTstr, it is possible to generate the two-dimensional optical reflection image data DTrf2 that does not reflect the target portion that is blocked by the structure and cannot be observed from the viewpoint.

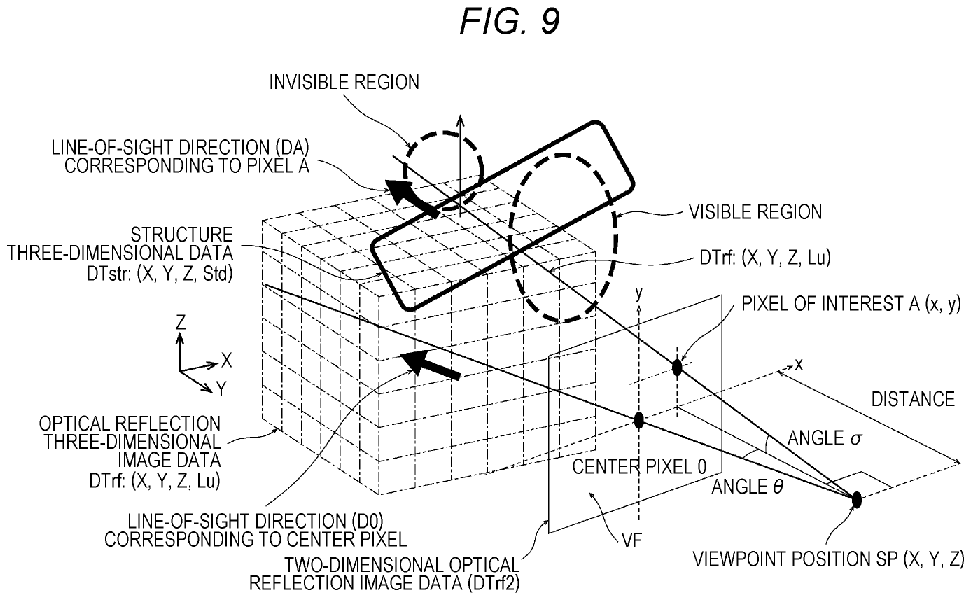

FIG. 9 is a schematic view for describing an outline of a method of calculating the two-dimensional optical reflection image data DTrf2 in the two-dimensional single viewpoint reflection component image conversion processing.

The two-dimensional single viewpoint reflection component image conversion processing unit 314 generates a plurality of values when the optical reflection image indicated by the three-dimensional optical reflection image data DTrf is observed in the line-of-sight direction from a preset viewpoint position (X, Y, Z) by changing the angles θ and σ of the line-of-sight direction, and generates the two-dimensional optical reflection image data DTrf2 by two-dimensionally arranging the values of the obtained optical reflection image. Specifically, as illustrated in FIG. 9, an arbitrary viewpoint position SP (X, Y, Z) is set in the three-dimensional space, and a virtual image plane VF is set at a position separated from the viewpoint position SP (X, Y, Z) by a predetermined distance in the direction of the three-dimensional structure indicated by the three-dimensional optical reflection image data DTrf. At this time, the virtual image plane VF is set such that a center O intersects a straight line passing through the viewpoint position SP (X, Y, Z) and the center voxel of the three-dimensional optical reflection image data DTrf. Further, an image frame of the virtual image plane VF is set according to the angle of view of the gas visualization imaging device 10. Then, a line-of-sight direction DA from the viewpoint position SP (X, Y, Z) toward a pixel of interest A (x, y) on the virtual image plane VF is a direction inclined by an angle θ in the X direction and an angle σ in the Y direction with respect to the line-of-sight direction DO toward the center pixel O, that is, the line-of-sight direction DO of the gas visualization imaging device. The voxel of the three-dimensional optical reflection image data that first intersects the line of sight is detected along the line-of-sight direction DA corresponding to the pixel of interest A (x, y). The voxel that first intersects with the line of sight starting at the viewpoint position SP (X, Y, Z) exists in a visible region when viewed from the viewpoint position SP (X, Y, Z). Thus, among the optical reflection luminance data Lu in the voxel, the optical reflection luminance data Lu emitted in the line-of-sight direction DA is calculated as a value of the two-dimensional optical reflection image data DTrf2 related to the pixel of interest A (x, y).

As illustrated in FIG. 9, in an invisible region that cannot be observed from the gas visualization imaging device 10 due to being blocked by a structure that first intersects the line of sight, the calculation of the two-dimensional optical reflection image data DTrf2 is not performed for the pixel of interest A (x, y) for a voxel existing behind the structure as viewed from the viewpoint position SP (X, Y, Z) in consideration of the three-dimensional position of the structure.

Then, while changing the angles θ and σ according to the angle of view of the gas visualization imaging device 10, the position of the pixel of interest A (x, y) is repeatedly moved, and the calculation of values of the two-dimensional optical reflection image data is repeated with all pixels on the virtual image plane VF as pixels of interest A (x, y), thereby calculating the two-dimensional optical reflection image data DTrf2.

Furthermore, by generating the two-dimensional optical reflection image data DTrf2 by varying the viewpoint position SP (X, Y, Z) using the same three-dimensional optical reflection image data DTrf, a plurality of pieces of two-dimensional optical reflection image data DTrf2 can be easily generated from one fluid simulation.

Returning to FIG. 6, the storage unit 33 has a function as a temporary storage area for temporarily storing a calculation result of the control unit 31 in addition to storing the program 331 and the like necessary for the machine learning data generating device 30 to operate. The storage unit 33 includes, for example, a volatile memory such as a DRAM and a nonvolatile memory such as a hard disk.

The communication unit 32 transmits and receives information to and from the machine learning data generating device 30 and the storage unit 40.

The display unit 34 is, for example, a liquid crystal panel or the like, and displays a display screen generated by the CPU 31.

<Generation Processing Operation of Machine Learning Data>

Next, as an example of a generation flow of the machine learning teacher data, a method of generating an image using three-dimensional simulation, that is, an operation of generating the two-dimensional optical reflection image data DTrf2 by the machine learning data generating device 30 will be described.

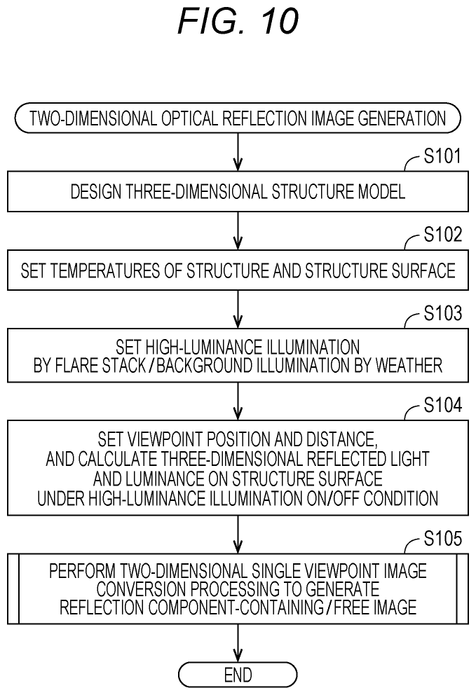

FIG. 10 is a flowchart illustrating an outline of two-dimensional optical reflection image generation processing as a teacher image in the machine learning data generating device 30.

First, the three-dimensional structure model design is performed in the three-dimensional structure modeling unit 311 on the basis of the operation input of the condition parameter CP1 related to the structure condition (step S101), and the structure three-dimensional data DTstr is output to the subsequent stage.

Next, on the basis of the operation input of the condition parameter CP2 related to the temperature condition, the temperature setting unit 312 of respective parts sets the temperatures of the structure and the surface of the structure (step S102), assigns the temperature condition to each part of the structure surface, and outputs the structure radiation three-dimensional data DTemt on the surface of the structure laid out in the three-dimensional space.

Next, on the basis of the operation input of the condition parameter CP3 related to the illumination condition, high-luminance illumination by the flare stack/background illumination by the weather are set (step S103), and the viewpoint position and the distance are set. Using other condition parameters as common conditions, the three-dimensional optical illumination analysis simulation execution unit 313 calculates the three-dimensional reflected light and the luminance on the structure surface under the high-luminance illumination ON/OFF condition using the known optical illumination analysis simulation software (step S104), generates a pair of pieces of the three-dimensional optical reflection image data DTrf corresponding to the high-luminance illumination ON/OFF, and outputs the pair of pieces of the three-dimensional optical reflection image data DTrf to the subsequent stage.

Next, on the basis of the operation input of the condition parameter CP4 regarding the image capturing condition, the two-dimensional single viewpoint reflection component image conversion processing unit 314 performs two-dimensional single viewpoint image conversion processing to generate the reflection component-containing/free image (step S105), and outputs the pair of pieces of the reflection component-containing image data DTrfon and the reflection component-free image data DTrfoff corresponding to the high-luminance illumination ON/OFF as the machine learning teacher data.

Next, a two-dimensional single viewpoint reflection component image conversion processing method will be described.

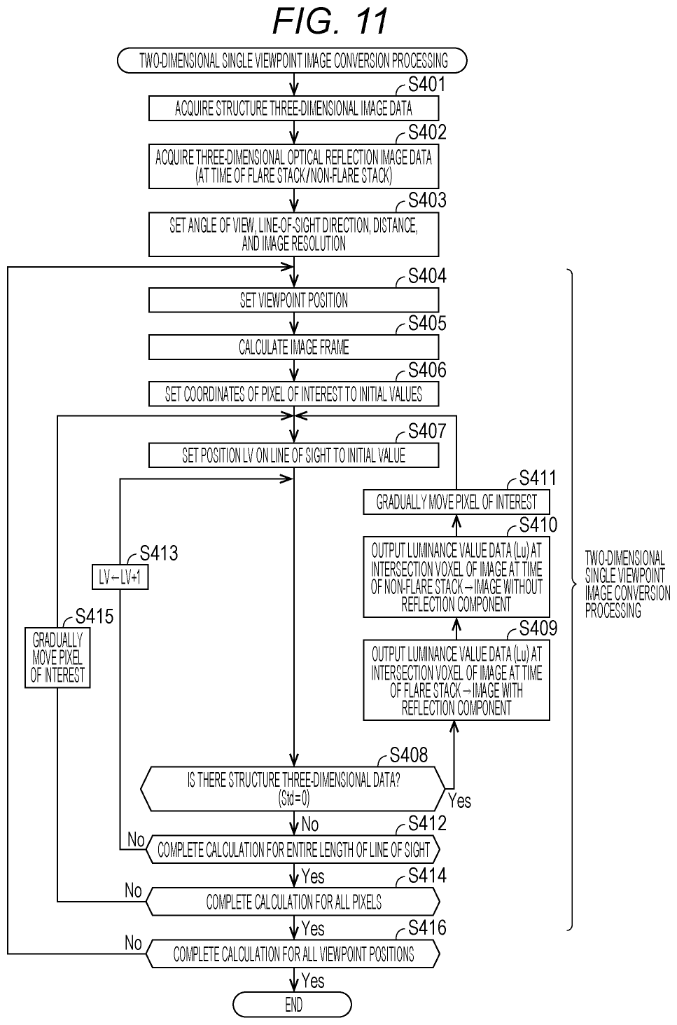

FIG. 11 is a flowchart illustrating an outline of two-dimensional single viewpoint reflection component image conversion processing. This processing is executed by the two-dimensional single viewpoint reflection component image conversion processing unit 314 whose function is configured by the control unit 31.

First, the two-dimensional single viewpoint reflection component image conversion processing unit 314 acquires the structure three-dimensional data DTstr (step S401), acquires the three-dimensional optical reflection image data DTrf (at the time of flare/high-luminance illumination ON condition), and further acquires the three-dimensional optical reflection image data DTrf (at the time of non-flare/high-luminance illumination OFF condition) (step S402).

Next, on the basis of an operation input, for example, an input of information regarding the imaging device angle of view, the line-of-sight direction, the distance, and the image resolution is received as the condition parameter CP4 (step S403). Furthermore, the viewpoint position SP (X, Y, Z) corresponding to the position of an imaging portion of the gas visualization imaging device 10 is set in the three-dimensional space on the basis of the operation input (step S404).

Next, the virtual image plane VF separated from the viewpoint position SP (X, Y, Z) by a predetermined distance in the direction of the three-dimensional structure is set, and as described above, the position of the image frame of the virtual image plane VF is calculated according to the angle of view of the gas visualization imaging device 10 (step S405).

Next, the coordinates of the pixel of interest A (x, y) are set to initial values (step S406), and a position LV on the line of sight from the viewpoint position SP (X, Y, Z) toward the pixel of interest A (x, y) on the virtual image plane VF is set to an initial value (step S407).

Next, it is determined whether or not the structure identification information Std of the voxel of the structure three-dimensional data DTstr intersecting the line of sight represents “without structure” (Std=0) (step S408).

In a case where the structure three-dimensional data DTstr intersecting the line of sight is “with structure” in step 408, the luminance value data (Lu) at the intersection voxel with the three-dimensional optical reflection image data DTrf (high-luminance illumination on condition) at the time of flare stack is output as an image with a reflection component (step S409), the luminance value data (Lu) at the intersection voxel with the dimensional optical reflection image data DTrf (high-luminance illumination off condition) at the time of non-flare stack is output as an image with a reflection component (step S410), the position of the pixel of interest A (x, y) is gradually moved (step S411), and the process returns to step S407.

On the other hand, in a case where it is not “with structure”, it is determined whether or not the calculation is completed for the entire length of the line of sight corresponding to the range in which the line of sight and the voxel intersect (step S412), and in a case where the calculation is not completed, the position LV on the line of sight is incremented by the unit length (step S413), and the process returns to step S408. On the other hand, in a case where the calculation has been completed, it is determined whether or not the calculation has been completed for all the pixels on the virtual image plane VF (step S414). In a case where the calculation has not been completed, the position of the pixel of interest A (x, y) is gradually moved (step S415), the process returns to step S407, and in a case where the calculation has been completed, the process ends. A standard value set in a case where there is no structure is determined as the luminance value data of the pixel of interest A. Here, the standard value is, for example, luminance value data corresponding to the ground or the sky in the real space. The standard value can be obtained by appropriately setting the conditions indicated by the condition parameters CP1 and CP2.

As described above, respective pieces of the two-dimensional optical reflection image data DTrf2 at the time of flare stack and at the time of non-flare stack are generated for each of all the pixels on the virtual image plane VF. That is, a set of the reflection component-containing image data DTrfon and the reflection component-free image data DTrfoff related to the virtual image plane VF is generated.

Next, it is determined whether or not the generation of the two-dimensional optical reflection image data DTrf2 has been completed for all viewpoint positions SP (X, Y, Z) to be calculated (step S416). In a case where the generation has not been completed, the process returns to step S404 and the two-dimensional optical reflection image data DTrf2 is generated for a new viewpoint position SP (X, Y, Z) input by operation, and in a case where the generation has been completed, the process ends.

As described above, three-dimensional optical illumination analysis simulation is performed while various setting conditions are changed in various ways, and from a result thereof, three-dimensional optical reflection image data is acquired under the high-luminance illumination OFF condition and the high-luminance illumination ON condition. Then, by performing conversion into two-dimensional optical reflection image data by the two-dimensional single viewpoint processing, it is possible to efficiently generate a large amount of sets of learning data including a pair of reflection component-free image data and reflection component-containing image data under the same condition.

In an inspection of a gas facility, it is considered effective to identify the position of a gas leakage source hidden behind an equipment facility such as complicated piping from the inspection image using machine learning. However, machine learning generally requires tens of thousands of correct data, and in order to achieve the machine learning, it is necessary to efficiently acquire a large amount of teacher learning data related to gas facilities.

On the other hand, by using the machine learning data generating device 30, it is possible to efficiently generate a large number of sets of learning data and contribute to improvement of learning accuracy.

<Generation Processing Operation of Machine Learning Data>

Hereinafter, the operation of the reflection-component-reduced image generating device 20 according to the present embodiment will be described with reference to the drawings.

<Learning Phase>

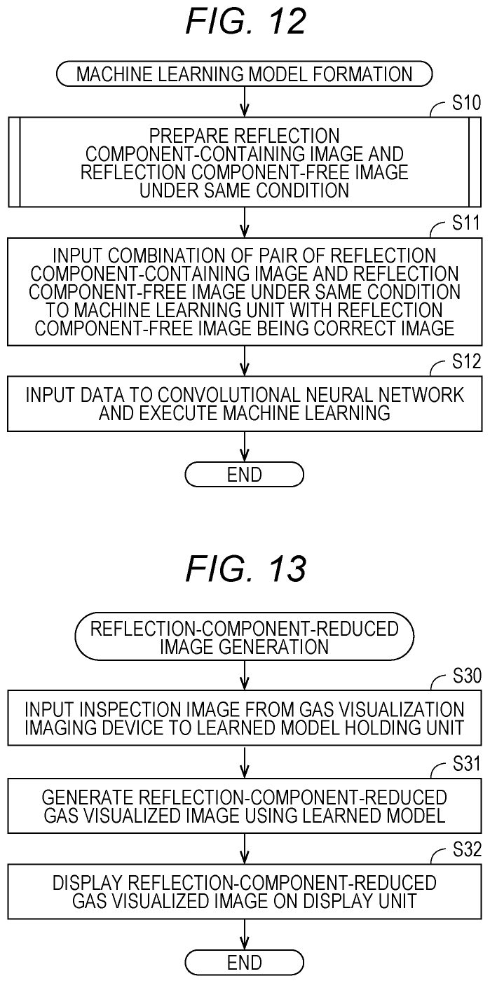

FIG. 12 is a flowchart illustrating the operation of the reflection-component-reduced image generating device 20 in a learning phase.

First, the machine learning data generating device 30 creates a combination of a pair of pieces of the reflection component-containing image data DTrfon and the reflection component-free image data DTrfoff under an equivalent condition (step S10) corresponding to high-luminance illumination ON/OFF. Each set of teacher images includes time-series data of a plurality of frames.

As the pair of the reflection component-containing image data DTrfon and the reflection component-free image data DTrfoff under the same condition corresponding to high-luminance illumination ON/OFF, two-dimensional optical reflection image data observed from a predetermined viewpoint position, converted from three-dimensional optical reflection image data can be used. The three-dimensional optical reflection image data may be based on three-dimensional optical illumination analysis simulation. For example, three-dimensional structure modeling of a gas facility may be performed using commercially available three-dimensional computer-aided design (CAD) software, three-dimensional optical illumination analysis simulation may be performed using commercially available three-dimensional optical illumination analysis simulation software in consideration of a structure model, and three-dimensional optical reflection image data obtained as a simulation result may be converted into a two-dimensional image observed from the predetermined viewpoint position and generated.

Next, the combination of the pair of pieces of the reflection component-containing image data DTrfon and the reflection component-free image data DTrfoff under the equivalent condition corresponding to the high-luminance illumination ON/OFF is input to the machine learning unit 2141 with the reflection component-free image being the correct image (step S11). The reflection component-containing image data DTrfon is input to the training image input unit 212, and the corresponding reflection component-free image data DTrfoff is input to the correct image input unit 213. At this time, image data subjected to processing such as gain adjustment may be input as necessary.

Next, data is input to the convolutional neural network to execute the machine learning (step S12). Thus, the parameters are optimized by trial and error by deep learning, and a machine-learned model is formed. The formed machine-learned model is held in the learning model holding unit 2142.

By the above operation, a machine-learned model that outputs an image in which the high-luminance reflection components is reduced on the basis of the characteristics of an image including the high-luminance reflected light is formed.

<Operation of Generating Reflection-Component-Reduced Image>

FIG. 13 is a flowchart illustrating an operation of the reflection-component-reduced image generating device 20 in an operation phase.

First, the inspection image acquired by the gas visualization imaging device 10 is input from the inspection image input unit 211 to the learned model holding unit 2142 (step S30). The inspection image is image data in the same format as that of the teacher image, and includes time-series data of a plurality of frames. The inspection image is an infrared image captured by the infrared camera of the gas visualization imaging device 10, and is a moving image illustrating a gas distribution obtained by visualizing a gas leakage portion as an inspection target. Subtraction of an offset component or gain adjustment may be performed on the inspection image. In a case where the high-luminance light generated by the flare stack or the like is imaged, a background image portion in which an imaging target such as a gas facility is irradiated with light is included in the inspection image as a high-luminance reflection component. A part of each frame of the captured image may be cut out so as to include all pixels in which gas is detected, and the inspection image may be generated as a frame of the gas distribution image.

Next, a reflection-component-reduced image is generated using the learned model (step S31). By using the machine-learned model formed in step S12, the reflection-component-reduced image in which the high-luminance reflection component included in the inspection image is reduced is generated using the inspection image as an input.

Next, the high-luminance reflection-component-reduced image is displayed on the display unit (step S32). The reflection-component-reduced image is generated by the processing.

<Summary>

When a gas visualized image under an environment in which high-luminance light source illumination such as the flare stack exists was input to the reflection-component-reduced image generating device 20 according to the present embodiment according to the above configuration, a gas visualized image in which the reflection component is satisfactorily removed was obtained.

As a technique for reducing the influence of a luminance change in visualization of gas from an infrared moving image, for example, Patent Literature 3 discloses a technique for inputting captured images of at least two different exposure times to remove a flicker component. This is a technique for removing a flicker generated in an illumination light source such as a fluorescent lamp, but the flicker to be removed is periodic, and it has been difficult to remove a random luminance change similar to the flare stack.

On the other hand, according to the reflection-component-reduced image generating device 20 of the present embodiment, an image in which a reflection component by the high-luminance light source illumination is removed from a gas leakage image is generated using a learning model obtained by machine learning using an image illuminated with the high-luminance light source and the image not illuminated as a learning set, so that the influence of a change in the amount of infrared rays by the high-luminance light source can be eliminated, and the detection rate of gas leakage can be improved.

As described above, the reflection-component-reduced image generating device according to the present embodiment can reduce the influence of a change in the amount of infrared rays due to the high-luminance light source in a gas facility from the output image of the gas visualization imaging device, and can contribute to the improvement of detection quality in gas leakage detection.

<First Modification>

Although the reflection-component-reduced image generating device 20 according to the first embodiment has been described above, the present disclosure is not limited to the above embodiment at all except for essential characteristic components thereof. Hereinafter, as an example of such a mode, a modification of the above-described embodiment will be described.

In a first modification, an example in which two-dimensional optical reflection image data DTrf2 is acquired by imaging will be described. An example of actually acquiring image-capturing experimental data using the gas visualization imaging device is illustrated.

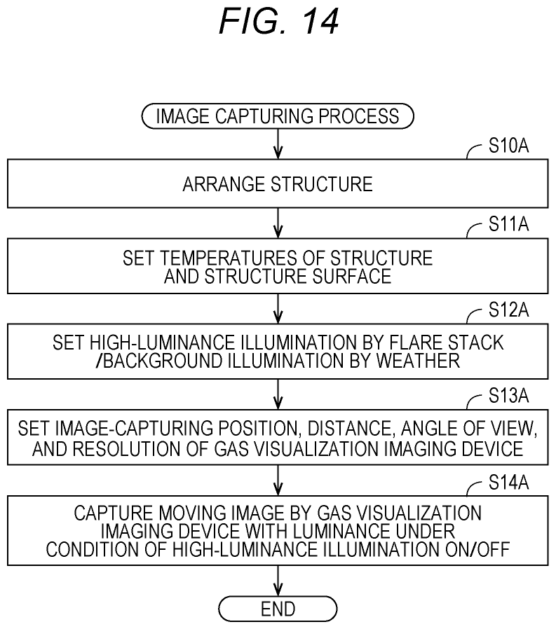

FIG. 14 is a process diagram illustrating an outline of an imaging process of a teacher image.

First, a structure is arranged in a studio or the like (step S10A). In this case, in the structure arrangement setting, as illustrated in the structure conditions in Table 1, the position of the structure to be the imaging subject and the optical characteristic conditions of the structure surface are set. As the structure, simulated plant equipment simulating plant equipment or a structure capable of performing the image-capturing experiment under illumination by a high-luminance illumination light source such as a model structure is used. Surface processing such as painting is performed in order to equalize optical characteristics of the structure surface to those of actual plant equipment.

Next, the temperature of the structure and the temperature of the structure surface are set using a heating device (step S11A). Here, as illustrated in the temperature conditions of Table 1, the temperature of the structure itself and the temperature around the structure are set as illustrated in the temperature conditions of Table 1 in order to reflect a change in the amount of infrared rays depending on the season in learning.

Next, the high-luminance illumination by the flare stack is set using a high-luminance illumination light source, and background illumination by weather is set using natural light or normal illumination (step S12A). Here, as illustrated in the illumination conditions of Table 1, the high-luminance illumination is illumination that generates a reflection component to be removed in this case. In addition to the temporal change of the intensity, the position and the number are set. It is assumed that the background illumination is illumination for reproducing a change in illuminance due to the weather, and its intensity is sufficiently lower than that of the high-luminance illumination and changes slowly over time.

Then, in the infrared camera of the gas visualization imaging device, image capturing conditions such as an image capturing position, a distance, an angle of view, and resolution are set (step S13A), and the gas visualization imaging device captures a moving image with luminance under the condition with/without high-luminance illumination (step S14A). Here, as illustrated in the image capturing conditions in Table 1, image capturing conditions such as the angle of view and the viewpoint of the imaging device are set.

The reflection component-free image is acquired by imaging in the high-luminance illumination OFF state while variously changing the various settings described above, and then the reflection component-containing image is acquired by imaging in the high-luminance illumination ON state, and various learning data can be acquired.

When a gas visualization image under an environment in which high-luminance light source illumination such as the flare stack existed was input to the reflection component removed image generating device, a gas visualized image in which a reflection component is satisfactorily removed was obtained.

<<Second Embodiment>>

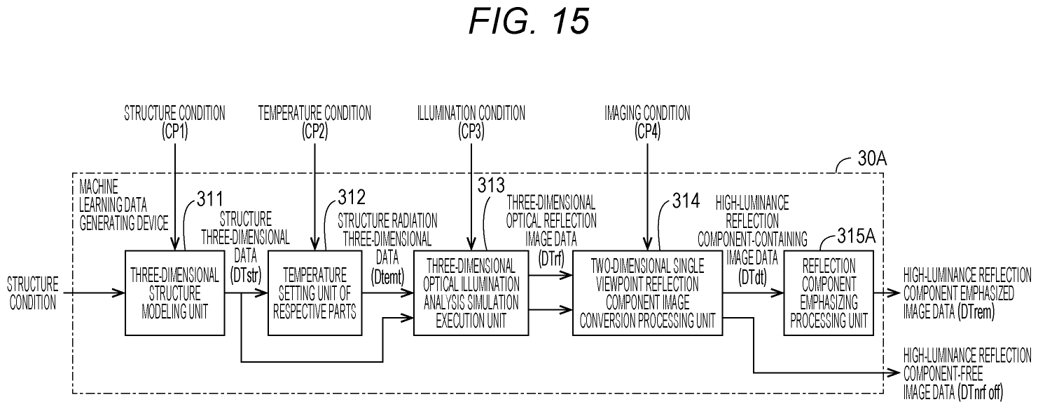

Hereinafter, a machine learning data generating device 30A according to a second embodiment will be described. FIG. 15 is a functional block diagram in a control unit of the machine learning data generating device 30A. The condition parameters necessary for processing input in each functional block in FIG. 15 are as illustrated in the above table. The same components as those of the machine learning data generating device 30 are denoted by the same reference numerals, and description thereof is omitted.

<Configuration>

The machine learning data generating device 30A is different from the machine learning data generating device 30 in that a reflection component emphasizing processing unit 315A is newly provided at a subsequent stage of the two-dimensional single viewpoint reflection component image conversion processing unit 314. Reflection component emphasizing processing is emphasizing processing for a predetermined frequency with respect to a time-series image such that behavior of an image component of irradiating a target with the high-luminance light generated by the flare stack or the like can be emphasized.

The reflection component emphasizing processing unit 315A extracts a specific frequency component from the high-luminance reflection component-containing image data DTrfon, and performs various emphasizing processing on a high-luminance reflection image component caused by the flare stack or the like, thereby generating various reflection component emphasized image data DTrem.

<Operation of Reflection Component Emphasizing Processing>

Next, a reflection component emphasizing processing operation in the machine learning data generating device 30A will be described with reference to the drawings.

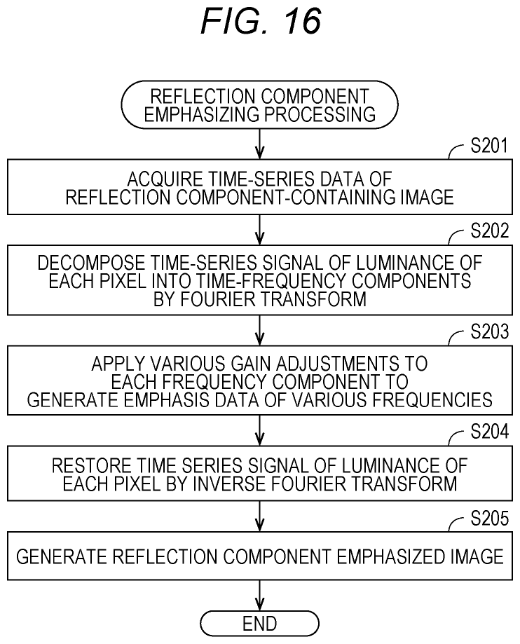

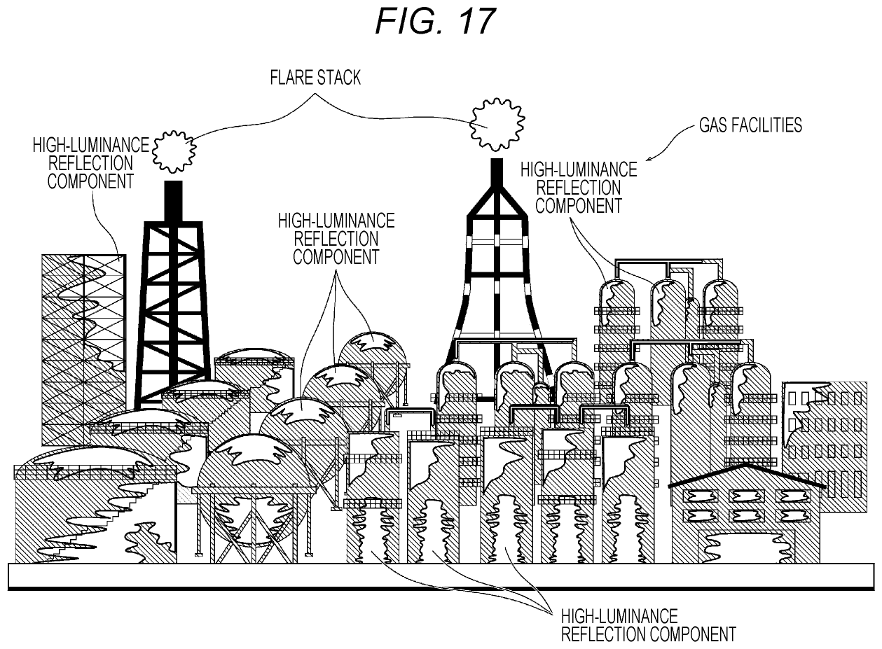

FIG. 16 is a flowchart illustrating an outline of the reflection component emphasizing processing. First, the reflection component emphasizing processing unit 315A acquires time-series data of the high-luminance reflection component-containing image data DTrfon (at the time of flare/high-luminance illumination ON condition) (step S201).

For the time-series pixel data, a time-series signal of luminance of each pixel is decomposed into time-frequency components (step S202). Here, for the time-frequency decomposition, a method such as Fourier transform or wavelet transform is used.

Next, specific frequency component data is extracted, and various gain adjustments are applied to each frequency component to generate emphasis data of various frequencies (step S203).

Next, the restored image is generated by restoring the time series signal of the luminance of each pixel (step S204). For the restoration into the time-series signal, a method such as inverse Fourier transform or inverse wavelet transform corresponding to the method used in the time frequency decomposition is used.

Finally, it is output as the reflection component emphasized image data DTrem (step S205), and the process ends.

<Summary>

As described above, the machine learning data generating device 30A can generate various reflection component emphasized image data DTrem by performing various emphasizing processing by changing the gain adjustment for each frequency component on the high-luminance reflection image component caused by the flare stack or the like. The generated reflection component emphasized image data DTrem and the reflection component-free image data DTrfoff can be used as a set as machine learning teacher data used in the reflection-component-reduced image generating device 20, so that a large number of sets of learning data can be efficiently generated, and it is possible to contribute to improvement of learning accuracy.

<<Other Modifications>>

Although the gas leakage detection device according to the embodiment has been described above, the present disclosure is not limited to the above embodiment except for essential characteristic components thereof. For example, the present disclosure also includes a mode obtained by applying various modifications conceived by those skilled in the art to the embodiments, and a mode achieved by arbitrarily combining components and functions of the embodiments without departing from the gist of the present invention. Hereinafter, as an example of such a mode, a modification of the above-described embodiment will be described.

(1) In the above-described embodiment, the description has been given by exemplifying the gas plant as the gas facility as an example of the inspection image. However, the present disclosure is not limited thereto, and may be applied to generation of a display image in an instrument, a device, a laboratory, a research laboratory, a factory, or a business place using gas.

(2) Although the present disclosure has been described based on the above embodiments, the present disclosure is not limited to the above embodiments, and the following cases are also included in the present invention.

For example, the present invention may be a computer system including a microprocessor and a memory, in which the memory stores the computer program, and the microprocessor operates according to the computer program. For example, a computer system that has a computer program of the processing in the reflection-component-reduced image generating system 1 of the present disclosure or the components thereof, and that operates according to the program (or instructing each connected part to operate) may be used.

Further, the present invention also includes a case where all or part of the processing in the reflection-component-reduced image generating system 1 or the components thereof is configured by a computer system including a microprocessor, a recording medium such as a ROM and a RAM, a hard disk unit, and the like. The RAM or the hard disk unit stores a computer program for achieving similar operation to those of the above devices. The microprocessor operates in accordance with the computer program, so that each device achieves its function.

Further, a part or all of the components constituting each of the above-described devices may be constituted by one system large scale integration (LSI). The system LSI is a super multifunctional LSI manufactured by integrating a plurality of components on one chip, and is specifically a computer system including a microprocessor, a ROM, a RAM, and the like. These may be individually integrated into one chip, or may be integrated into one chip so as to include a part or all of them. The RAM stores a computer program for achieving similar operations to those of each of the above devices. The microprocessor operates in accordance with the computer program, so that the system LSI achieves its functions. For example, the present invention also includes a case where the processing in the reflection-component-reduced image generating system 1 or the components thereof is stored as a program of the LSI, the LSI is inserted into a computer, and a predetermined program (gas inspection management method) is executed.

Note that, the method of circuit integration is not limited to LSI, and may be achieved by a dedicated circuit or a general-purpose processor. An FPGA (Field Programmable Gate Array) that can be programmed after manufacturing of the LSI or a reconfigurable processor (Reconfigurable Processor) in which connections and settings of circuit cells inside the LSI can be reconfigured may be used.

Furthermore, when a circuit integration technology replacing the LSI appears due to the progress of the semiconductor technology or another derived technology, the functional blocks may be integrated using the technology.

Further, a part or all of the functions of the reflection-component-reduced image generating system 1 according to each embodiment or the components thereof may be achieved by a processor such as a CPU executing a program. A non-transitory computer-readable recording medium in which a program for performing the operation of the reflection-component-reduced image generating system 1 or the components thereof is recorded may be used. The program or signal may be recorded on a recording medium and transferred, so that the program may be implemented by another independent computer system. In addition, it goes without saying that the program can be distributed via a transmission medium such as the Internet.

Further, the reflection-component-reduced image generating system 1 according to the above embodiment or each component thereof may be implemented by a programmable device such as a CPU, a graphics processing unit (GPU), or a processor, and software. These components can be one circuit component, or can be an assembly of a plurality of circuit components. In addition, a plurality of components can be combined to form one circuit component, or can be an assembly of a plurality of circuit components.

(3) The division of the functional blocks is an example, and a plurality of functional blocks may be achieved as one functional block, one functional block may be divided into a plurality of functional blocks, or a part of functions may be transferred to another functional block. Further, functions of a plurality of functional blocks having similar functions may be processed in parallel or in a time division manner by single hardware or software.

Further, the order in which the above steps are executed is exemplified for specifically describing the present invention, and may be an order other than the above order. In addition, a part of the above steps may be executed simultaneously (in parallel) with other steps.

Further, at least a part of the functions of the respective embodiments and the modifications thereof may be combined. Furthermore, the numbers used above are all exemplified to specifically describe the present invention, and the present invention is not limited to the illustrated numbers.

<<Summary>>

As described above, the reflection-component-reduced image generating device according to the present embodiment includes:
an inspection image input unit that receives a gas distribution image as an input, the gas distribution image having a visualized presence region of a gas in a space and including an image portion in which a target is irradiated with light; and
a reflection-component-reduced image generating unit that generates a reflection-component-reduced image in which an image component of reflected light in the image portion of the gas distribution image received by the inspection image input unit is reduced using an estimation model machine-learned using, as teacher data, a combination of a first image including an image portion in which a target is irradiated with light and a second image including an image portion in which the target is not irradiated with light, the second image being equivalent to the first image for elements other than the image portion

Further, in another aspect, in any one of the above aspects, a configuration may be employed in which the estimation model is an estimation model machine-learned with the second image as a correct image.

Further, in another aspect, in any one of the above aspects, a configuration may be employed in which the image input to the inspection image input unit, the first image, and the second image are moving images including a plurality of frames.

Further, in another aspect, in any one of the above aspects, a configuration may be employed in which an image component of the reflected light is a time-varying component in the image portion in which the target is irradiated with the light.

Further, in another aspect, in any one of the above aspects, a configuration may be employed in which the first image is an image obtained by amplifying a specific frequency component in a time direction.

Further, in another aspect, in any one of the above aspects, a configuration may be employed in which the first image is an image obtained by simulation.

Further, in another aspect, in any one of the above aspects, a configuration may be employed in which the light to irradiate the target is light emitted from a light source based on a flare stack.

Further, in another aspect, in any one of the above aspects, a configuration may be employed in which
the image portion in the first image in which the target is irradiated with light includes an image component of reflected light based on a flare stack, and
the image portion in the second image in which the target is not irradiated with light does not include an image component of reflected light based on the flare stack.

Further, a reflection component reduction inference model generating device according to the present embodiment may have a configuration including;
an image input unit; and
a machine learning unit that generates an inference model that uses, as teacher data, a combination of a first image including an image portion in which a target is irradiated with light and a second image including an image portion in which the target is not irradiated with light and equivalent to the first image for elements other than the image portion, executes machine learning with an image including an image portion in which a target is irradiated with light as an input, and outputs a reflection-component-reduced image in which an image component of reflected light in the image portion is reduced.

Further, in another aspect, in any one of the above aspects, a configuration may be employed in which the image input to the inspection image input unit, the first image, and the second image are moving images including a plurality of frames.

Further, in another aspect, in any one of the above aspects, a configuration may be employed in which an image component of the reflected light is a time-varying component of a high-luminance portion in the image portion in which the target is irradiated with the light.

Further, in another aspect, in any one of the above aspects, a configuration may be employed in which the first image is an image obtained by amplifying a specific frequency component in a time direction.

Further, a reflection-component-reduced image generating method according to the present embodiment may have a configuration including:
receiving a gas distribution image as an input, the gas distribution image having a visualized presence region of a gas in a space and including an image portion in which a target is irradiated with light; and
generating a reflection-component-reduced image in which an image component of reflected light in the image portion of the gas distribution image received by the inspection image input unit is reduced using an estimation model machine-learned using, as teacher data, a combination of a first image including an image portion in which a target is irradiated with light and a second image including an image portion in which the target is not irradiated with light, the second image being equivalent to the first image for elements other than the image portion.

Furthermore, a program according to the present embodiment is a program for causing a computer to perform reflection-component-reduced image generation processing, in which
the reflection-component-reduced image generation processing may be configured to include
receiving a gas distribution image as an input, the gas distribution image having a visualized presence region of a gas in a space and including an image portion in which a target is irradiated with light, and
generating a reflection-component-reduced image in which an image component of reflected light in the image portion of the gas distribution image received by the inspection image input unit is reduced using an estimation model machine-learned using, as teacher data, a combination of a first image including an image portion in which a target is irradiated with light and a second image including an image portion in which the target is not irradiated with light, the second image being equivalent to the first image for elements other than the image portion.

<<Supplement>>

Each of the embodiments described above illustrates a preferred specific example of the present invention. Numerical values, components, arrangement positions and connection modes of the components, processing methods, order of processing, and the like illustrated in the embodiments are merely examples, and are not intended to limit the present invention. Further, among the components in the embodiment, components that are not described in the independent claims indicating the highest concepts of the present invention are described as optional components constituting a more preferable mode.

Further, the order in which the above method is executed is for the purpose of specifically describing the present invention, and may be an order other than the above. In addition, a part of the above method may be executed simultaneously (in parallel) with another method.

Further, in order to facilitate understanding of the invention, scales of components in the respective drawings described in the above embodiments may be different from actual scales. Further, the present invention is not limited by the description of each embodiment described above, and can be appropriately changed without departing from the gist of the present invention.

Industrial Applicability

A machine learning data generating device, a machine learning data generating method, and learning data set according to embodiments of the present disclosure are widely applicable to a system that uses gas leakage of a gas facility for inspection.

### REFERENCE SIGNS LIST

1 Reflection-component-reduced image generating system
10 Gas visualization imaging device
20 Reflection-component-reduced image generating device
21 Control unit (CPU)
1210 Reflection-component-reduced image generating unit
211 Inspection image input unit
212 Training image input unit
213 Correct image input unit
214 Reflection component reducing unit
2141 Machine learning unit
2142 Learning model holding unit
215 Determination result output unit
22 Communication unit
23 Storage unit
231 Program
24 Display unit
25 Operation input unit
30 Machine learning data generating device
31 Control unit (CPU)
311 Three-dimensional structure modeling unit
312 Temperature setting unit of respective parts
313 Three-dimensional optical illumination analysis simulation execution unit
314 Two-dimensional single viewpoint reflection component image conversion processing unit
315 Reflection component emphasizing processing unit
32 Communication unit
33 Storage unit
331 Program
34 Display unit
35 Operation input unit
40 Storage unit

1. A reflection-component-reduced image generating device, comprising:
a first hardware processor that receives a gas distribution image as an input, the gas distribution image having a visualized presence region of a gas in a space and including an image portion in which a target is irradiated with light; and
a second hardware processor that generates a reflection-component-reduced image in which an image component of reflected light in the image portion of the gas distribution image received by the first hardware processor is reduced using an estimation model machine-learned using, as teacher data, a combination of a first image including an image portion in which a target is irradiated with light and a second image including an image portion in which the target is not irradiated with light, the second image being equivalent to the first image for elements other than the image portion.

2. The reflection-component-reduced image generating device according to claim 1, wherein
the estimation model is an estimation model machine-learned with the second image as a correct image.

3. The reflection-component-reduced image generating device according to claim 1, wherein
the image input to the first hardware processor, the first image, and the second image are moving images including a plurality of frames.

4. The reflection-component-reduced image generating device according to claim 1, wherein
an image component of the reflected light is a time-varying component in the image portion in which the target is irradiated with the light.

5. The reflection-component-reduced image generating device according to claim 1, wherein
the first image is an image obtained by amplifying a specific frequency component in a time direction.

6. The reflection-component-reduced image generating device according to claim 1, wherein
the first image is an image obtained by simulation.

7. The reflection-component-reduced image generating device according to claim 1, wherein
the light to irradiate the target is light emitted from a light source based on a flare stack.

8. The reflection-component-reduced image generating device according to claim 1, wherein
the image portion in the first image in which the target is irradiated with light includes an image component of reflected light based on a flare stack, and
the image portion in the second image in which the target is not irradiated with light does not include an image component of reflected light based on the flare stack.

9. A reflection component reduction inference model generating device, comprising:
a third hardware processor; and
a fourth hardware processor that generates an inference model that uses, as teacher data, a combination of a first image including an image portion in which a target is irradiated with light and a second image including an image portion in which the target is not irradiated with light and equivalent to the first image for elements other than the image portion, executes machine learning with an image including an image portion in which a target is irradiated with light as an input, and outputs a reflection-component-reduced image in which an image component of reflected light in the image portion is reduced.

10. The reflection component reduction inference model generating device according to claim 9, wherein
an image input to the third hardware processor, the first image, and the second image are moving images including a plurality of frames.

11. The reflection component reduction inference model generating device according to claim 9, wherein
the image component of the reflected light is a time-varying component of a high-luminance portion in the image portion in which the target is irradiated with the light.

12. The reflection component reduction inference model generating device according to claim 9, wherein
the first image is an image obtained by amplifying a specific frequency component in a time direction.

13. A reflection-component-reduced image generating method, comprising:
receiving a gas distribution image as an input, the gas distribution image having a visualized presence region of a gas in a space and including an image portion in which a target is irradiated with light; and
generating a reflection-component-reduced image in which an image component of reflected light in the image portion of the gas distribution image received in the receiving is reduced using an estimation model machine-learned using, as teacher data, a combination of a first image including an image portion in which a target is irradiated with light and a second image including an image portion in which the target is not irradiated with light, the second image being equivalent to the first image for elements other than the image portion.

14. A non-transitory recording medium storing a computer readable program for causing a computer to perform reflection-component-reduced image generation processing, wherein
the reflection-component-reduced image generation processing includes
receiving a gas distribution image as an input, the gas distribution image having a visualized presence region of a gas in a space and including an image portion in which a target is irradiated with light, and
generating a reflection-component-reduced image in which an image component of reflected light in the image portion of the gas distribution image received in the receiving is reduced using an estimation model machine-learned using, as teacher data, a combination of a first image including an image portion in which a target is irradiated with light and a second image including an image portion in which the target is not irradiated with light, the second image being equivalent to the first image for elements other than the image portion.

15. The reflection-component-reduced image generating device according to claim 2, wherein
the image input to the first hardware processor, the first image, and the second image are moving images including a plurality of frames.

16. The reflection-component-reduced image generating device according to claim 2, wherein
an image component of the reflected light is a time-varying component in the image portion in which the target is irradiated with the light.

17. The reflection-component-reduced image generating device according to claim 2, wherein
the first image is an image obtained by amplifying a specific frequency component in a time direction.

18. The reflection-component-reduced image generating device according to claim 2, wherein
the first image is an image obtained by simulation.

19. The reflection-component-reduced image generating device according to claim 2, wherein
the light to irradiate the target is light emitted from a light source based on a flare stack.

20. The reflection-component-reduced image generating device according to claim 2, wherein
the image portion in the first image in which the target is irradiated with light includes an image component of reflected light based on a flare stack, and
the image portion in the second image in which the target is not irradiated with light does not include an image component of reflected light based on the flare stack.
